(19) United States
(12) Patent Application Publication
(10) Pub. No.: US 2025/0039401 A1
(43) Pub. Date: Jan. 30, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Junru LI, Beijing (CN); Yue Li, Los Angeles, CA (US); Kai Zhang, Los Angeles, CA (US); Li Zhang, Los Angeles, CA (US)

(21) Appl. No.: 18/913,890

(22) Filed: Oct. 11, 2024

Related U.S. Application Data
(63) Continuation of application No. PCT/CN2023/087613, filed on Apr. 11, 2023.

(30) Foreign Application Priority Data
Apr. 12, 2022 (WO) PCT/CN2022/086468

(51) Int. Cl. H04N 19/154; H04N 19/176

(52) U.S. Cl. CPC H04N 19/154; H04N 19/176

(57) ABSTRACT

Embodiments of the present disclosure provide a solution for video processing. A method for video processing is proposed. The method comprises: determining, for a conversion between a current video block of a video and a bitstream of the video, a distortion value of the current video block based on a set of distortion metrics, the set of distortion metrics comprising at least one of: a first distortion metric determined according to a first machine learning model, a second distortion metric determined according to a second machine learning model, or a third distortion metric determined without using the first and second machine learning models; and performing the conversion based on the distortion value. In this way, a rate-distortion optimization process based on the distortion value can be improved, and thus the coding performance can be enhanced.

### CROSS REFERENCE TO RELATED APPLICATIONS

This application is a continuation of International Application No. PCT/CN2023/087613, filed on Apr. 11, 2023, which claims the benefit of International Application No. PCT/CN2022/086468 filed on Apr. 12, 2022. The entire contents of these applications are hereby incorporated by reference in their entireties.

### FIELD

Embodiments of the present disclosure relates generally to video coding techniques, and more particularly, to distortion determination with machine learning model.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, for a conversion between a current video block of a video and a bitstream of the video, a distortion value of the current video block based on a set of distortion metrics, the set of distortion metrics comprising at least one of: a first distortion metric determined according to a first machine learning model, a second distortion metric determined according to a second machine learning model, or a third distortion metric determined without using the first and second machine learning models; and performing the conversion based on the distortion value.

The method in accordance with the first aspect of the present disclosure determines a distortion value of the current video block based on a set of distortion metrics. The determined distortion value may be applied in a rate-distortion optimization (RDO) process, and thus can improve the RDO process. In this way, the coding effectiveness and coding efficiency can be improved.

In a second aspect, another method for video processing is proposed. The method comprises: determining, for a conversion between a current video block of a video and a bitstream of the video, whether to apply a machine learning model in a rate-distortion optimization (RDO) process for a coding tool of the current video block; performing the RDO process on the current video block based on the determining; and performing the conversion based on the RDO process.

The method in accordance with the second aspect of the present disclosure determines whether to apply a machine learning model in a RDO process for a coding tool of the current video block. In this way, the coding effectiveness and coding efficiency can be improved.

In a third aspect, an apparatus for processing video data is proposed. The apparatus for processing video data comprising a processor and a non-transitory memory with instructions thereon, wherein the instructions upon execution by the processor, cause the processor to perform a method in accordance with the first or second aspect of the present disclosure.

In a fourth aspect, a non-transitory computer-readable storage medium is proposed. The non-transitory computer-readable storage medium storing instructions that cause a processor to perform a method in accordance with the first or second aspect of the present disclosure.

In a fifth aspect, a non-transitory computer-readable recording medium is proposed. The non-transitory computer-readable recording medium stores a bitstream of a video which is generated by a method performed by a video processing apparatus, wherein the method comprises: determining a distortion value of a current video block of the video based on a set of distortion metrics, the set of distortion metrics comprising at least one of: a first distortion metric determined according to a first machine learning model, a second distortion metric determined according to a second machine learning model, or a third distortion metric determined without using the first and second machine learning models; and generating the bitstream based on the distortion value.

In a sixth aspect, a method for storing a bitstream of a video is proposed. The method comprises: determining a distortion value of a current video block of the video based on a set of distortion metrics, the set of distortion metrics comprising at least one of: a first distortion metric determined according to a first machine learning model, a second distortion metric determined according to a second machine learning model, or a third distortion metric determined without using the first and second machine learning models; generating the bitstream based on the distortion value; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by a video processing apparatus, wherein the method comprises: determining whether to apply a machine learning model in a rate-distortion optimization (RDO) process for a coding tool of a current video block of the video; performing the RDO process on the current video block based on the determining; and generating the bitstream based on the RDO process.

In an eighth aspect, another method for storing a bitstream of a video is proposed. The method comprises: determining whether to apply a machine learning model in a rate-distortion optimization (RDO) process for a coding tool of a current video block of the video; performing the RDO process on the current video block based on the determining; generating the bitstream based on the RDO process; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing an example of raster-scan slice partitioning of a picture;

FIG. 5 illustrates an example diagram showing an example of rectangular slice partitioning of a picture;

FIG. 6 illustrates an example diagram showing an example of a picture partitioned into tiles, bricks, and rectangular slices;

FIG. 7A illustrates an example diagram showing CTBs crossing the bottom picture border;

FIG. 7B illustrates an example diagram showing CTBs crossing the right picture border;

FIG. 7C illustrates an example diagram showing CTBs crossing the right bottom picture border;

FIG. 8 illustrates an example diagram showing an example of encoder block diagram;

FIG. 9 illustrates an example diagram showing an illustration of picture samples and horizontal and vertical block boundaries on the 8×8 grid, and the nonoverlapping blocks of the 8×8 samples;

FIG. 10 illustrates an example diagram showing pixels involved in filter on/off decision and strong/weak filter selection;

FIGS. 11A-111D illustrate example diagrams showing four 1-D directional patterns for EO sample classification;

FIGS. 12A-12C illustrate example diagrams showing examples of GALF filter shapes;

FIGS. 13A-13C illustrate example diagrams showing examples of relative coordinator for the 5×5 diamond filter support;

FIG. 14 illustrates an example diagram showing examples of relative coordinates for the 5×5 diamond filter support;

FIG. 15A illustrates an example diagram showing Architecture of the proposed CNN filter;

FIG. 15B illustrates an example diagram showing a construction of ResBlock (residual block) in the CNN filter;

FIG. 16 illustrates a flowchart of a method for video processing in accordance with some embodiments of the present disclosure;

FIG. 17 illustrates another flowchart of a method for video processing in accordance with some embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

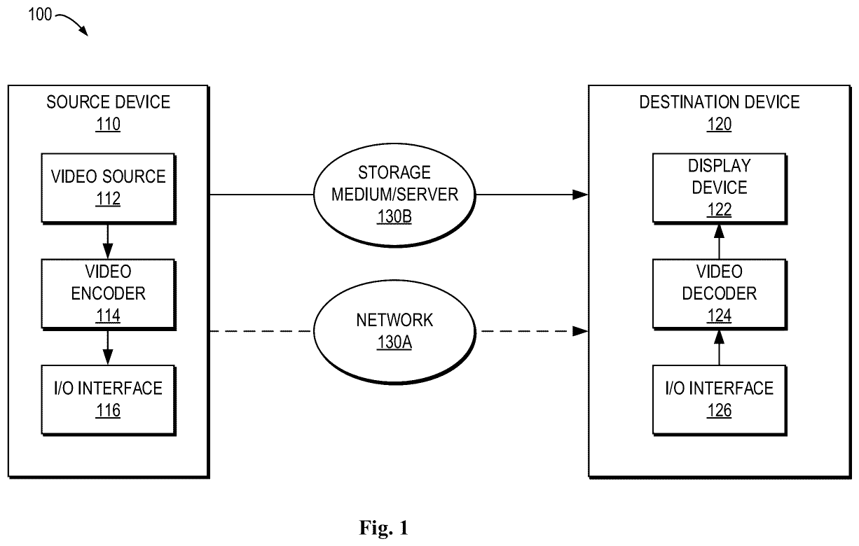

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

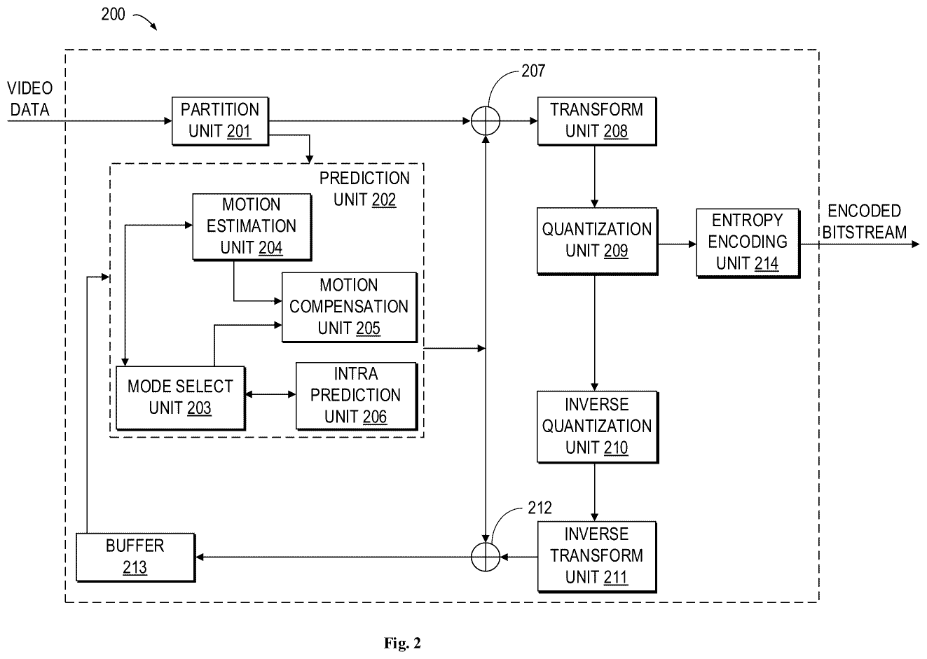

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

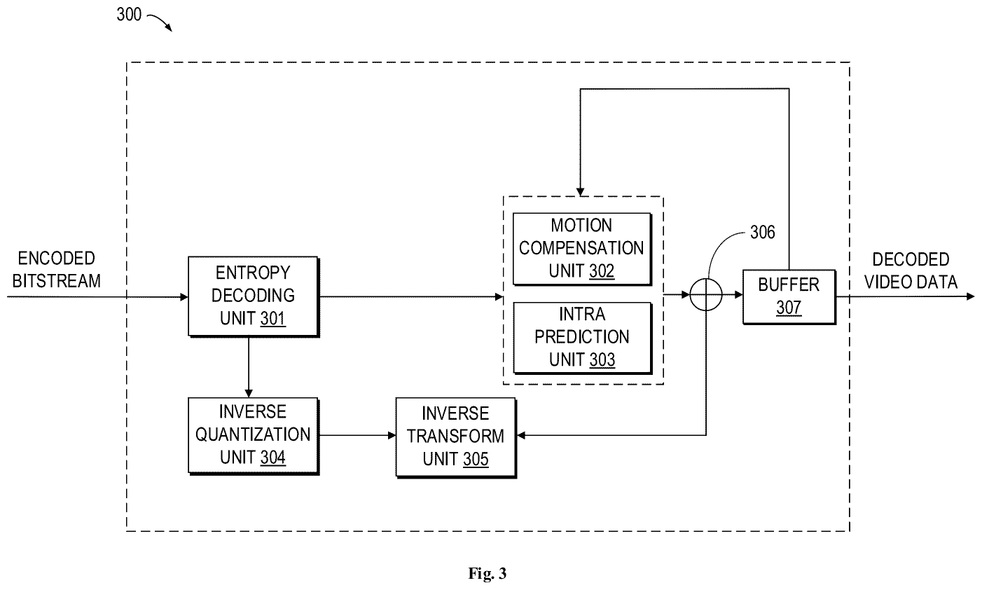

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

The latest version of VVC draft, i.e., Versatile Video Coding (Draft 10) could be found at:
http://phenix.it-sudparis.eu/jvet/doc_end_user/current_document.php?id=10399

The latest reference software of VVC, named VTM, could be found at:
https://vegit.hhi.fraunhofer.de/jvet/VVCSoftware_VTM/-/tags/VTM-10.0

### 2.1. Color Space and Chroma Subsampling

Color space, also known as the color model (or color system), is an abstract mathematical model which simply describes the range of colors as tuples of numbers, typically as 3 or 4 values or color components (e.g., RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries. Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF. 1.261, and MPEG-1, Cb and Cr are sited interstitially, halfway between alternate luma samples.
In 4:2:0 DV Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

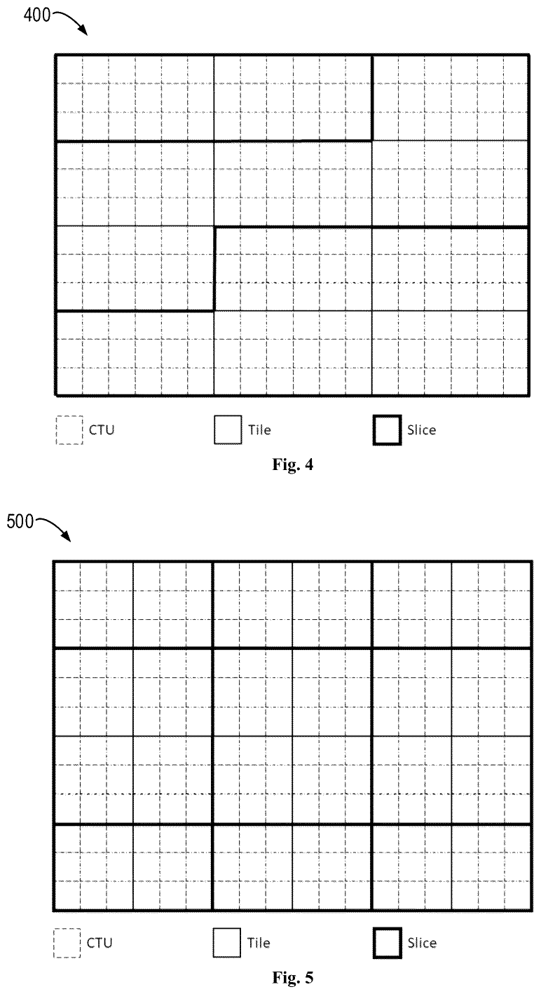

FIG. 4 illustrates an example diagram 400 showing an example of raster-scan slice partitioning of a picture. In FIG. 4, the picture is divided into 12 tiles and 3 raster-scan slices. The picture in FIG. 4 with 18 by 12 luma CTUs is partitioned into 12 tiles and 3 raster-scan slices (informative).

FIG. 5 illustrates an example diagram 500 showing an example of rectangular slice partitioning of a picture. In FIG. 5, the picture is divided into 24 tiles (6 tile columns and 4 tile rows) and 9 rectangular slices. The picture in FIG. 5 with 18 by 12 luma CTUs is partitioned into 24 tiles and 9 rectangular slices (informative).

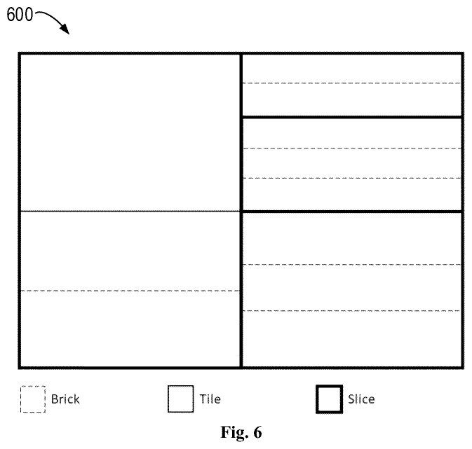

FIG. 6 illustrates an example diagram 600 showing an example of a picture partitioned into tiles, bricks, and rectangular slices. In FIG. 6, the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. The picture in FIG. 6 is partitioned into 4 tiles, 11 bricks, and 4 rectangular slices (informative).

### 2.2.1. CTU/CTB Sizes

In VVC, the CTU size, signaled in SPS by the syntax element log 2_ctu_size_minus2, could be as small as 4×4.

### 7.3.2.3 Sequence Parameter Set RBSP Syntax

| seq_parameter_set_rbsp( ) { | Descriptor |
|---|---|
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? | |
| 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < ! rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma | |
| != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log 2_min_luma_coding_block_size_minus2 plus 2 specifies the minimum luma coding block size.

The variables CtbLog2SizeY, CtbSizeY, MinCbLog2SizeY, MinCbSizeY, MinThLog2SizeY, MaxTbLog2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$Ctb Log 2 SizeY = log 2 \_ctu \_size \_minus 2 + 2 \qquad ( 7 - 9 )$$

$$CtbSizeY = 1 << Ctb Log 2 SizeY \qquad ( 7 - 10 )$$

$$Min Cb Log 2 SizeY = log2\_min \_luma \_coding \_block \_size \_minus 2 + 2 \qquad ( 7 - 11 )$$

$$Min CbSizeY = 1 << Min Cb Log 2 SizeY \qquad ( 7 - 12 )$$

$$Min Tb Log 2 SizeY = 2 \qquad ( 7 - 13 )$$

$$Max Tb Log 2 SizeY = 6 \qquad ( 7 - 14 )$$

$$Min TbSizeY = 1 << Min Tb Log 2 SizeY \qquad ( 7 - 15 )$$

$$Max TbSizeY = 1 << Max Tb Log 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthIn Min CbsY = pic\_width \_in \_luma \_samples / Min CbSizeY \qquad ( 7 - 20 )$$

$$PicHeightIn Min CbsY = pic\_height \_in \_luma \_samples / Min CbSizeY \qquad ( 7 - 21 )$$

$$PicSizeIn Min CbsY = PicWidthIn Min CbsY * PicHeightIn Min CbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC . \qquad ( 7 - 25 )$$

2.2.2. CTUs in a Picture

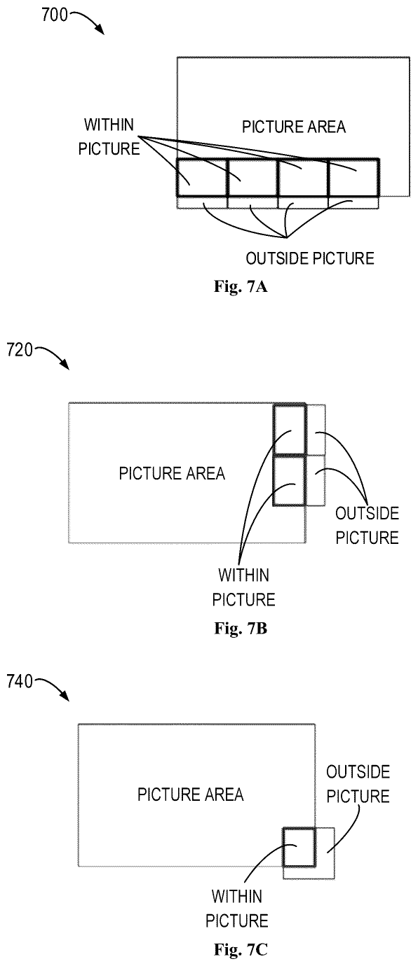

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. FIG. 7A illustrate an example diagram 700 showing CTBs crossing the bottom picture border, in which K=M, L<N. FIG. 7B illustrates an example diagram 720 showing CTBs crossing the right picture border, in which K<M, L=N. FIG. 7C illustrates an example diagram 740 showing CTBs crossing the right bottom picture border, in which K<M, L<N. For those CTBs as depicted in FIGS. 7A-7C, the CTB size is still equal to M×N, however, the bottom boundary/right boundary of the CTB is outside the picture.

### 2.3. Coding Flow of a Typical Video Codec

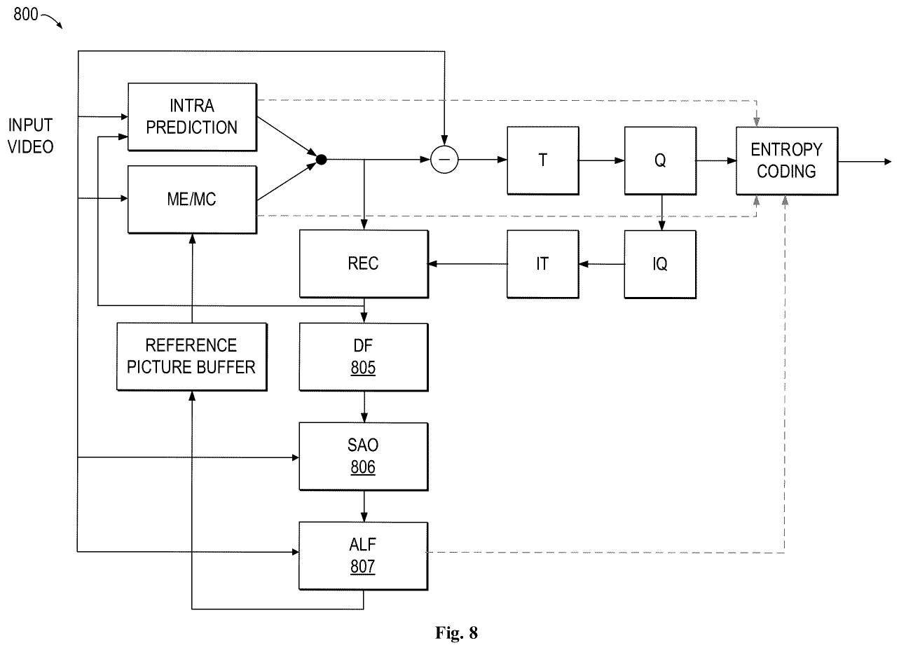

FIG. 8 illustrates an example diagram 800 showings an example of encoder block diagram of VVC, which contains three in-loop filtering blocks: deblocking filter (DF) 805, sample adaptive offset (SAO) 806 and ALF 807. Unlike DF 805, which uses predefined filters, SAO 806 and ALF 807 utilize the original samples of the current picture to reduce the mean square errors between the original samples and the reconstructed samples by adding an offset and by applying a finite impulse response (FIR) filter, respectively, with coded side information signaling the offsets and filter coefficients. ALF 807 is located at the last processing stage of each picture and can be regarded as a tool trying to catch and fix artifacts created by the previous stages.

### 2.4. Deblocking Filter (DB)

The input of DB is the reconstructed samples before in-loop filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

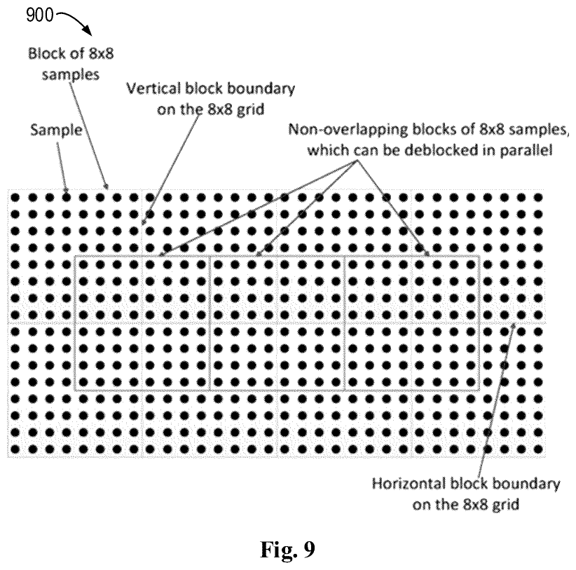

FIG. 9 illustrates an example diagram 900 showing an illustration of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS [xDᵢ] [yDⱼ] (wherein [xDᵢ] [yDⱼ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent blocks is | 2 | 2 | 2 |
| | intra | | | |
| 4 | TU boundary and at least one of the | 1 | 1 | 1 |
| | adjacent blocks has non-zero transform | | | |
| | coefficients | | | |
| 3 | Reference pictures or number of MVs | 1 | N/A | N/A |
| | (1 for uni-prediction, 2 for bi- | | | |
| | prediction) of the adjacent blocks are | | | |
| | different | | | |
| 2 | Absolute difference between the motion | 1 | N/A | N/A |
| | vectors of same reference picture | | | |
| | that belong to the adjacent blocks is | | | |
| | greater than or equal to one integer | | | |
| | luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent blocks is | 2 | 2 | 2 |
| | intra | | | |
| 7 | TU boundary and at least one of the | 1 | 1 | 1 |
| | adjacent blocks has non-zero transform | | | |
| | coefficients | | | |
| 6 | Prediction mode of adjacent blocks is | 1 | | |
| | different (e.g., one is IBC, one is | | | |
| | inter) | | | |
| 5 | Both IBC and absolute difference | 1 | N/A | N/A |
| | between the motion vectors that belong | | | |
| | to the adjacent blocks is greater than | | | |
| | or equal to one integer luma sample | | | |
| 4 | Reference pictures or number of | 1 | N/A | N/A |
| | MVs (1 for uni-prediction, 2 for bi- | | | |
| | prediction) of the adjacent blocks are | | | |
| | different | | | |
| 3 | Absolute difference between the motion | 1 | N/A | N/A |
| | vectors of same reference picture | | | |
| | that belong to the adjacent blocks is | | | |
| | greater than or equal to one integer | | | |
| | luma sample | | | |
| 1 | Otherwise | 0 | 0 | 0 |

### 2.4.3. Deblocking Decision for Luma Component

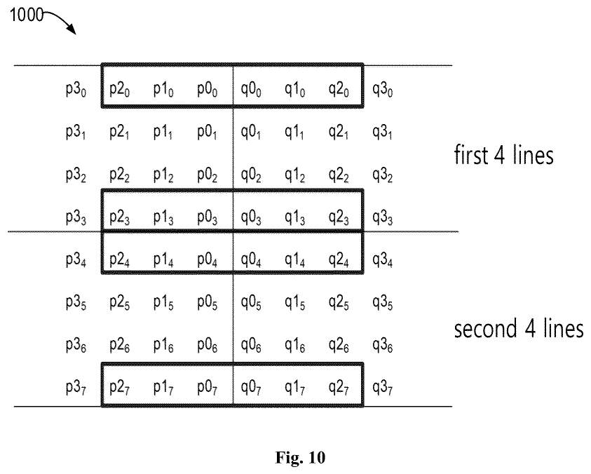

The deblocking decision process is described in this sub-section. FIG. 10 illustrates an example diagram 1000 showing pixels involved in filter on/off decision and strong/weak filter selection.

Wider-stronger luma filter is filters are used only if all the Condition1, Condition2 and Condition 3 are TRUE. The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.
bSidePisLargeBlk=((edge type is vertical and p₀ belongs to CU with width>=32)∥(edge type is horizontal and p₀ belongs to CU with height>=32))? TRUE: FALSE
bSideQisLargeBlk=((edge type is vertical and q₀ belongs to CU with width>=32)∥(edge type is horizontal and q₀ belongs to CU with height>=32))? TRUE: FALSE

Based on bSidePisLargeBlk and bSideQisLargeBlk, the condition 1 is defined as follows.

Condition1=(bSidePisLargeBlk∥ bSidePisLargeBlk)? TRUE: FALSE

Next, if Condition 1 is true, the condition 2 will be further checked. First, the following variables are derived:
dp0, dp3, dq0, dq3 are first derived as in HEVC
if (p side is greater than or equal to 32)

$$dp 0 = ( dp 0 + Abs ( p {5}_{0} - 2 * p {4}_{0} + p {3}_{0} ) + 1 ) >> 1$$

$$dp 3 = ( dp 3 + Abs ( p {5}_{3} - 2 * p {4}_{3} + p {3}_{3} ) + 1 ) >> 1$$

if (q side is greater than or equal to 32)

$$dq 0 = ( dq 0 + Abs ( p {5}_{0} - 2 * q {4}_{0} + q {3}_{0} ) + 1 ) >> 1$$

$$dq 3 = ( dq 3 + Abs ( q {5}_{3} - 2 * q {4}_{3} + q {3}_{3} ) + 1 ) >> 1$$

Condition2=(d<β)? TRUE: FALSE
where d=dp0+dq0+dp3+dq3.

If Condition1 and Condition2 are valid, whether any of the blocks uses sub-blocks is further checked:

```
If (bSidePisLargeBlk)
  {
      If (mode block P == SUBBLOCKMODE)
        Sp =5
      else
        Sp =7
}
else
  Sp = 3
If (bSideQisLargeBlk)
  {
      If (mode block Q == SUBBLOCKMODE)
        Sq =5
      else
        Sq =7
    }
else
  Sq = 3
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp₃ = Abs( p₃ − p₀ ), derived as in HEVC
if (p side is greater than or equal to 32)
    if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) + 1) >> 1
  else
    sq₃ = ( sq₃ + Abs( q₇ − q₃ ) + 1) >> 1
```

As in HEVC, StrongFilterCondition=(dpq is less than (β>>2), sp₃+sq₃ is less than (3*β>>5), and Abs(p₀−q₀) is less than (5*tc+1)>>1)? TRUE: FALSE.

### 2.4.4. Stronger Deblocking Filter for Luma (Designed for Larger Blocks)

Bilinear filter is used when samples at either one side of a boundary belong to a large block. A sample belonging to a large block is defined as when the width>=32 for a vertical edge, and when height>=32 for a horizontal edge. The bilinear filter is listed below.

Block boundary samples pᵢ for i=0 to Sp−1 and qᵢ for j=0 to Sq−1 (pᵢ and qᵢ are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm t c P {D}_{i}$$

$${q}_{i}^{′} = ( {g}_{j} * {Middle}_{s , t} + ( 64 - {g}_{j} ) * {Q}_{s} + 32 ) ≫ 6 ) , clipped to {q}_{j} \pm t c P {D}_{j}$$

where tcPDᵢ and tcPDⱼ term is a position dependent clipping described in Section 2.4.7 and gⱼ, fᵢ, Middle_{s,t}, Pₛ and Qₛ are given below.

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped. Chroma deblocking is performed when bS is equal to 2, or bS is equal to 1 when a large block boundary is detected. The second and third condition is basically the same as HEVC luma strong filter decision as follows.

In the second condition:
d is then derived as in HEVC luma deblocking.

The second condition will be TRUE when d is less than β.

In the third condition StrongFilterCondition is derived as follows:
dpq is derived as in HEVC.
sp₃=Abs(p₃−p₀), derived as in HEVC.
sq₃=Abs(q₀−q₃), derived as in HEVC.

As in HEVC design, StrongFilterCondition=(dpq is less than ((β>>2), sp₃+sq₃ is less than (β>>3), and Abs(p₀−q₀) is less than (5*tc+1)>>1).

### 2.4.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) >> 3 ,$$

$${p}_{1}^{′} = ( 2 * {p}_{3} + {p}_{2} + 2 * {p}_{1} + {p}_{0} + {q}_{0} + {q}_{1} + 4 ) >> 3 ,$$

$${p}_{0}^{′} = ( {p}_{3} + {p}_{2} + {p}_{1} + 2 * {p}_{0} + {q}_{0} + {q}_{1} + {q}_{2} + 4 ) >> 3.$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

Tc7={6, 5, 4, 3, 2, 1, 1}; Tc3={6,4,2};
tcPD=(Sp==3)? Tc3: Tc7;
tcQD=(Sq==3)? Tc3: Tc7.

For the P or Q boundaries being filtered with a short symmetrical filter, position dependent threshold of lower magnitude is applied:

Tc3={3, 2, 1}.

Following defining the threshold, filtered p ‘t and q’; sample values are clipped according to tcP and tcQ clipping values:

$${p}_{i}^{″} = Clip 3 ( {p}_{i}^{′} + {tcP}_{i} , {p}_{i}^{′} - {tcP}_{i} , {p}_{i}^{′} ) ; \\ {q}_{j}^{″} = Clip 3 ( {q}_{j}^{′} + {tcQ}_{j} , {q}_{j}^{′} - {tcQ}_{j} , {q}_{j}^{′} ) ;$$

where p′ᵢ and q′ᵢ are filtered sample values, p′ᵢ and q′ⱼ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 || edge == (orthogonalLength − 2) || edge ==
    (56 / 4) || edge == (72 / 4))
      Sp = Sq = 2;
    else
      Sp = Sq = 3;
  else
    Sp = Sq = bSideQisLargeBlk ? 5:3
}
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal. FIG. 11A illustrates an example diagram 1100 showing a 1-D directional pattern for EO sample classification with horizontal (EO class=0). FIG. 11B illustrates an example diagram 1120 showing a 1-D directional pattern for EO sample classification with vertical (EO class=1). FIG. 11C illustrates an example diagram 1140 showing a 1-D directional pattern for EO sample classification with 135° diagonal (EO class=2). FIG. 11D illustrates an example diagram 1160 showing a 1-D directional pattern for EO sample classification with 45° diagonal (EO class=3). For a given EO class, each sample inside the CTB is classified into one of five categories. The current sample value, labeled as “c,” is compared with its two neighbors along the selected 1-D pattern. The classification rules for each sample are summarized in Table 1. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | (c < a && c == b) \|\| (c == a && c < b) |
| 3 | (c > a && c == b) \|\| (c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption is applied. For the luma component, one among 25 filters is selected for each 2×2 block, based on the direction and activity of local gradients.

### 2.6.1. Filter Shape

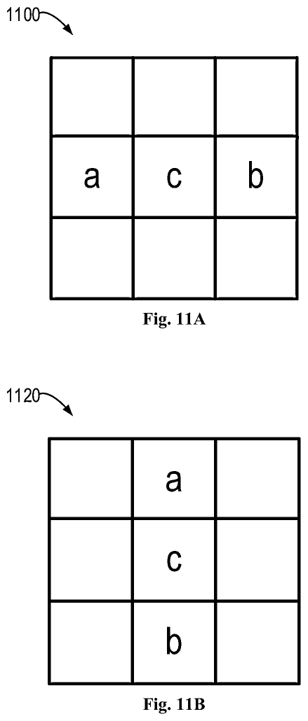

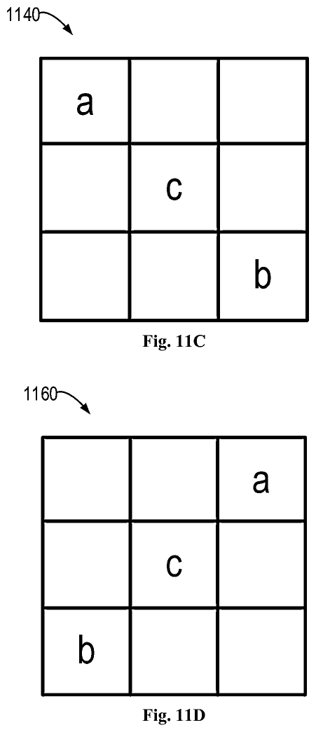

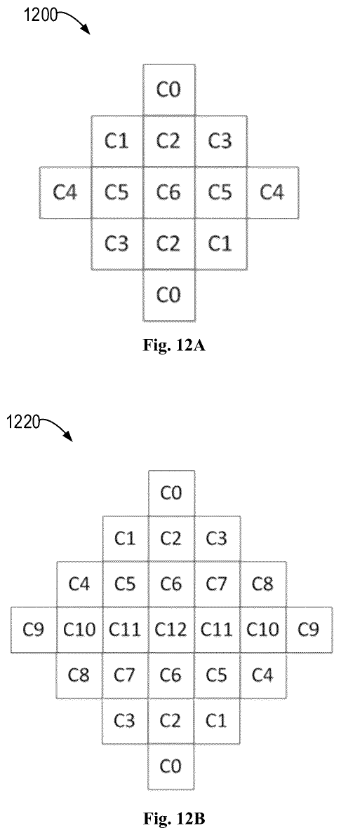

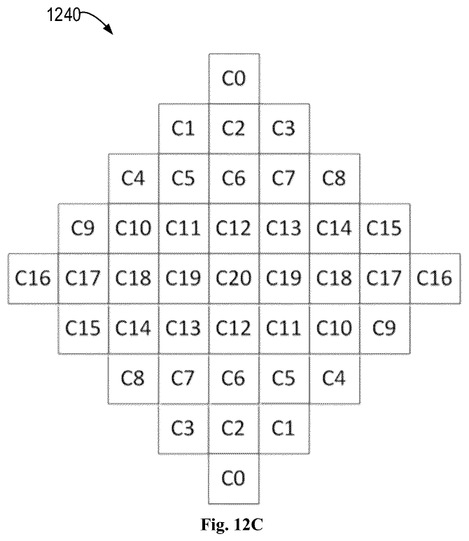

FIG. 12A illustrates an example diagram 1200 showing examples of GALF filter shapes with 5×5 diamond. FIG. 12B illustrates an example diagram 1220 showing examples of GALF filter shapes with 7×7 diamond. FIG. 12C illustrates an example diagram 1240 showing examples of GALF filter shapes with 9×9 diamond.

In the JEM, up to three diamond filter shapes (as shown in FIGS. 12A-12C) can be selected for the luma component.

An index is signalled at the picture level to indicate the filter shape used for the luma component. Each square represents a sample, and Ci (i being 0-6 (left), 0-12 (middle), 0-20 (right)) denotes the coefficient to be applied to the sample. For chroma components in a picture, the 5×5 diamond shape is always used.

### 2.6.1.1. Block Classification

Each 2×2 block is categorized into one out of 25 classes. The classification index C is derived based on its directionality D and a quantized value of activity Â, as follows:

$$C = 5 D + \hat{A} . \qquad ( 1 )$$

To calculate D and Â, gradients of the horizontal, vertical and two diagonal directions are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 4 )$$

$${g}_{d 2} = {\sum }_{k = i - 2}^{i + 3} {\sum }_{j = j - 3}^{j + 3} D {2}_{k , l} , D {2}_{k , l} = \vert 2 R ( k , l ) - R ( k - 1 , l + 1 ) - R ( k + 1 , l - 1 ) \vert . \qquad ( 5 )$$

Indices i and j refer to the coordinates of the upper left sample in the 2×2 block and R(i,j) indicates a reconstructed sample at coordinate (i, j).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) , \qquad ( 6 )$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) . \qquad ( 7 )$$

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.

Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e., a single set of ALF coefficients is applied for each chroma component.

### 2.6.1.2. Geometric Transformations of Filter Coefficients

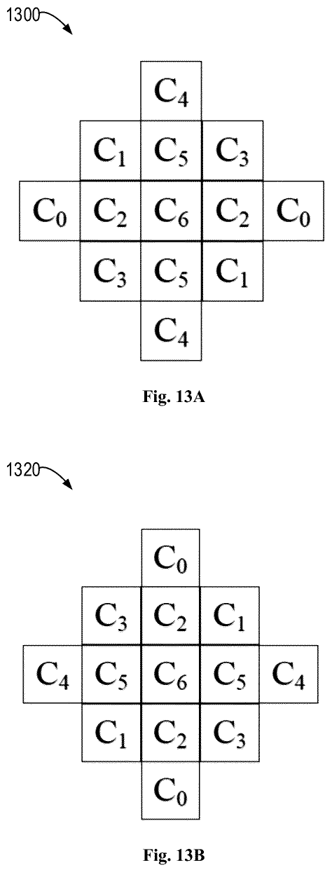

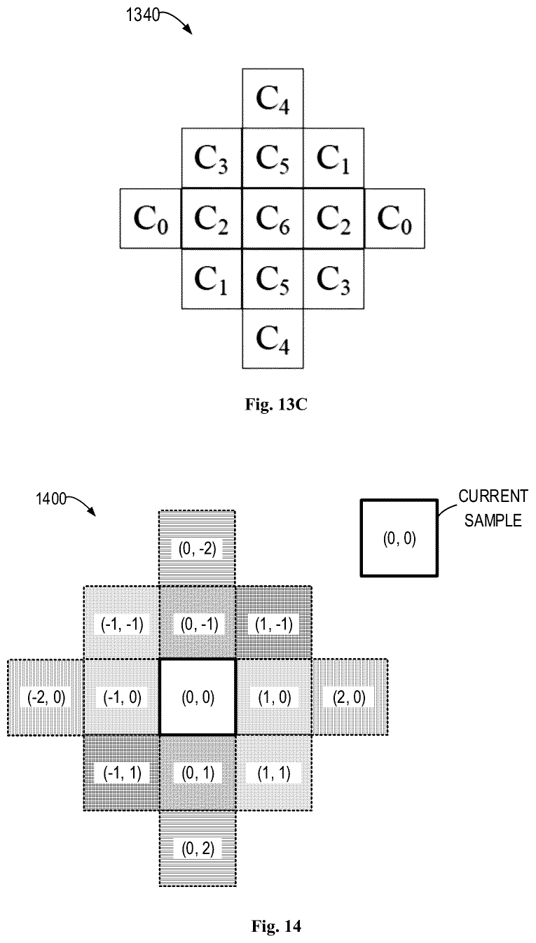

FIG. 13A illustrates an example diagram 1300 showing relative coordinator for the 5×5 diamond filter support (diagonal). FIG. 13B illustrates an example diagram 1320 showing relative coordinator for the 5×5 diamond filter support (vertical flip). FIG. 13C illustrates an example diagram 1340 showing relative coordinator for the 5×5 diamond filter support (rotation).

Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality. Three geometric transformations, including diagonal, vertical flip and rotation are introduced:

$$Diagonal : {f}_{D} ( k , l ) = f ( l , k ) , \\ Vertical flip : {f}_{V} ( k , l ) = f ( k , K - l - 1 ) , \\ Rotation : {f}_{R} ( k , l ) = f ( K - l - 1 , k ) . \qquad ( 9 )$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) depending on gradient values calculated for that block. The relationship between the transformation and the four gradients of the four directions are summarized in Table 4. FIGS. 12A-12C show the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f(k, l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i,j) within the block is filtered, resulting in sample value R′(i,j) as shown below, where L denotes filter length, f_{m,n} represents filter coefficient, and f(k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

FIG. 14 illustrates an example diagram 1400 showing examples of relative coordinates for the 5×5 diamond filter support. FIG. 14 shows an example of relative coordinates used for 5×5 diamond filter support supposing the current sample's coordinate (i, j) to be (0, 0). Samples in different coordinates filled with the same color are multiplied with the same filter coefficients.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) . I ( x + i , y + j ) , \qquad ( 11 )$$

where samples I(x+i,y+j) are input samples, O(x, y) is the filtered output sample (i.e. filter result), and w(i,j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) . I ( x + i , y + j ) + 64 ) ≫ 7 , \qquad ( 12 )$$

where L denotes the filter length, and where w(i, j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated, without coding efficiency impact, in the following expression:

$$O ( x , y ) = I ( x , y ) + {\sum }_{( i , j ) \neq ( 0 , 0 )} w ( i , j ) . ( I ( x + i , y + j ) - I ( x , y ) ) , \qquad ( 13 )$$

where w(i,j) are the same filter coefficients as in equation (11) [excepted w(0, 0) which is equal to 1 in equation (13) while it is equal to 1−Σ_{(i,j)≠(0,0)}w(i, j) in equation (11)].

Using this above filter formula of (13), VVC introduces the non-linearity to make ALF more efficient by using a simple clipping function to reduce the impact of neighbor sample values (I(x+i, y+j)) when they are too different with the current sample value (I(x, y)) being filtered.

More specifically, the ALF filter is modified as follows:

$${O}^{′} ( x , y ) = I ( x , y ) + {\sum }_{( i , j ) \neq ( 0 , 0 )} w ( i , j ) . K ( I ( x + i , y + j ) - I ( x , y ) , k ( i , j ) ) , \qquad ( 14 )$$

where K(d, b)=min(b, max(−b, d)) is the clipping function, and k(i,j) are clipping parameters, which depends on the (i,j) filter coefficient. The encoder performs the optimization to find the best k(i,j).

In some implementation, the clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} , \\ with M = {2}^{10} and N = 4. \qquad ( 15 )$$

Similarly, the Chroma tables of clipping values is obtained according to the following formula:

$${AlfClip}_{C} = \{ round ( A . {( {( \frac{M}{A} )}^{\frac{1}{N - 1}} )}^{N - n} ) for n ∈ 1 … N ] \} , \\ with M = {2}^{10} , N = 4 and A = 4. \qquad ( 16 )$$

TABLE 5
Authorized clipping values

| | INTRA/INTER tile group |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Convolutional Neural Network-Based Loop Filters for Video Coding

### 2.9.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.9.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks. For example, a fully connected network for the intra prediction is proposed. In addition to intra prediction, deep learning is also exploited to enhance other modules. For example, the in-loop filters of HEVC with a convolutional neural network is replaced and promising results are achieved. Neural networks are applied to improve the arithmetic coding engine.

### 2.9.3. Convolutional Neural Network Based In-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.9.3.1. Training

The purpose of the training processing is to find the optimal value of parameters including weights and bias. First, a codec (e.g., HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.9.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

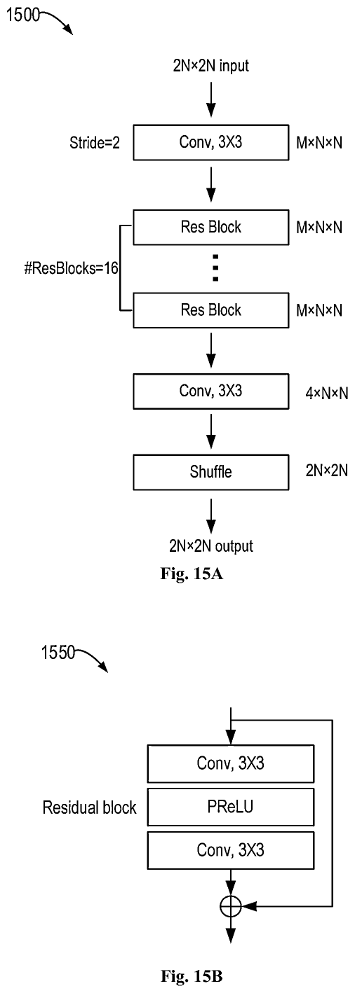

FIG. 15A illustrates an example diagram 1500 showing Architecture of the proposed CNN filter. FIG. 15B illustrates an example diagram 1550 showing a construction of ResBlock (residual block) in the CNN filter. In most of deep convolutional neural networks, residual blocks are utilized as the basic module and stacked several times to construct the final network wherein in one example, the residual block is obtained by combining a convolutional layer, a ReLU/PReLU activation function and a convolutional layer as shown in FIG. 15B.

### 2.9.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. PROBLEMS

The current NN filter has the following problems:

1. The prior art design of NN filter is only applied after the reconstruction of all blocks before in-loop filtering processes within a slice. Therefore, the impact of reduced distortion due to NN filter is not taken into consideration during the rate-distortion optimization (RDO) process, such as intra mode selection, partitioning selection, intra mode selection, inter mode selection, transform core selection, etc. The coding performance is sub-optimal considering:
a. The best mode (e.g., coding method/partitioning sizes) of current block selected in the RDO process could be wrong since the distortion is calculated without NN filter being applied.
b. The reconstruction and associated coded information of current block has big impact on coding of the subsequent blocks (e.g., due to intra prediction, or motion prediction). If the current block doesn't select the best mode, then the coding performance of sub-sequence block will also be sub-optimal.

### 4. DETAILED SOLUTIONS

The detailed embodiments below should be considered as examples to explain general concepts. These embodiments should not be interpreted in a narrow way. Furthermore, these embodiments can be combined in any manner. To solve the above problem, it is proposed to take the NN filter into consideration based on video content during the rate distortion optimization (RDO) process. This disclosure elaborates how to extend RDO purview with NN filter models, how to utilize NN filter models to select mode (e.g., intra mode, partitioning mode, inter mode or transform core), how to control the usage of NN filter models.

In the disclosure, a NN filter can be any kind of NN filter, such as a convolutional neural network (CNN) filter; alternatively, it could also be applied to non-NN based filters. In the following discussion, a NN filter may also be referred to as a CNN filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

The width and height of a video unit are denoted as W and H, respectively.

### On Utilization of the NN Filter Models to Select the Modes in the RDO Process

1. Whether to and/or how to utilize the NN filter models (or calculate the rate distortion cost) in RDO process may be dependent on the distortion D_{ORG} without NN filter model and/or the distortion Dⁿ_{NNLF} with n^{th} NN filter model (the model index is n−1, where n>=1). The RDO criterion is noted as J=D+lambda*R. “A distortion Dⁿ_{NNLF} with the n^{th} NN filter” may mean that the reconstruction samples are filtered by the n^{th} NN filter and the filtered reconstruction samples will be compared with the original samples to derive the distortion.
a. In one example, D in RDO criterion is the distortion with the n^{th} NN filter model. D=Dⁿ_{NNLF}.
   i. In one example, n is 1, 2, 3.
b. In one example, D in RDO criterion is the minimal value of the distortion without NN filter model and distortion with the n^{th} NN filter model. D=min(Dⁿ_{NNLF}, D_{ORG}).
   i. In one example, n is 1, 2, 3.
c. In one example, D in RDO criterion is the distortion with the best one of NN filter models.
   i. In one example, the best NN filter model is selected by distortion.
   ii. In one example, the best NN filter model is default one.
d. In one example, D in RDO criterion is the minimal value of distortion without NN filter model and the distortion with the best one of NN filter models.
   i. In one example, the best NN filter model is selected by distortion.
   ii. In one example, the best NN filter model is default one.
e. In one example, D in RDO criterion is a scaled version of the distortion without NN filter model, i.e. D=f*D_{ORG}.
   i. In one example, f is 1.0, 0.9, or 1.1.
f. In one example, D in RDO criterion is derived according to the distortion without NN filter model and the distortion with the n^{th} NN filter model.
   i. In one example, D=f₀*D_{ORG}+f₁*Dⁿ_{NNLF}.
      1) In one example, f₀=0.0, f₁=1.0.
      2) In one example, f₀=1.0, f₁=0.0.
   ii. In one example, D=min(f₀*D_{ORG}, f₁*Dⁿ_{NNLF}).
      1) In one example, f₀=1.0, f₁=1.0.
g. In one example, D in RDO criterion may be the combination of multiple calculating methods in the above inventions.
   i. In one example, the combination of calculating methods may be dependent on the coding statistics of the video unit (e.g., prediction modes, qp, temporal layer, slice type, etc.).
      1) In one example, the combination of calculating methods may be dependent on the type of candidate modes.
      2) In one example, when all or one of T candidate modes are NOT partitioning modes, D in RDO criterion is combination of the distortion with the p^{th} NN filter model and/or distortion without NN filter model.
         a. In one example, when the p^{th} NN filter model is NOT applied for one or all of T candidate modes, D in RDO criterion is the distortion without NN filter model (D=D_{ORG}).
         b. In one example, when the p^{th} NN filter model is applied for all or one of T candidate modes, D in RDO criterion is the distortion with the p^{th} NN filter model (D=DPNNLF).
      3) In one example, when all or one of T candidate modes are partitioning modes, D in RDO criterion is combination of the distortion with the q^{th} NN filter model and/or the distortion with the p^{th} NN filter model and/or distortion without NN filter model.
   ii. In one example, the combination may be dependent on the usage of the q^{th} NN filter model and/or the usage of the p^{th} NN filter model.
      1) In one example, when the q^{th} NN filter model is applied for all or one of T candidate modes, D in RDO criterion is the minimal value of the distortion without NN filter model and distortion with the q^{th} NN filter model (D=min(D^{q}_{NNLF}, D_{ORG})).
      2) In one example, when the q^{th} NN filter model is NOT applied for one or all of T candidate modes, D in RDO criterion is combination of the distortion with the p^{th} NN filter model and distortion without NN filter model.
         a. In one example, when the p^{th} NN filter model is applied for all of T candidate modes, D in RDO criterion is the distortion with the p^{th} NN filter model (D=D^{p}_{NNLF}).
         b. In one example, when the p^{th} NN filter model is NOT applied for one or all of T candidate modes, D in RDO criterion is the distortion without NN filter model (D=D_{ORG}).
   iii. In one example, the methods of calculating the D in RDO criterion may be applied according to the certain or adaptive order.
      1) In one example, the order of applying the methods of calculating the D in RDO criterion may be dependent on the coding modes/statistics of the video unit (e.g., prediction modes, qp, temporal layer, slice type, etc.).
      2) In one example, D=min(D^{q}_{NNLF}, D_{ORG}) may have a greater priority than D=D^{p}_{NNLF}.
      3) In one example, D=D^{p}_{NNLF} may have a greater priority than D=D_{ORG}.
   iv. In the above inventions, the p^{th} NN filter model may be the deblocking filter or SAO or ALF.
   v. In the above inventions, the q^{th} NN filter model may be the CNN filter.
   vi. In the above inventions, the q^{th} NN filter model may be same with the p^{th} NN filter model.
      1) In one example, p may be equal to q.
   vii. In the above inventions, T candidate modes may be the comparable modes with the RDO criterion noted as J=D+lambda*R.
      1) In one example, the number T of candidate modes may be equal to 1 or 2 or 3 or 4.
h. In the above inventions, the parameters f or f₀ or f₁ may be set according to the temporal layers and/or slice types.
i. In the above inventions, the parameters f or f₀ or f₁ may be set according to the QP (quantization parameter).
j. In the above inventions, the parameters f or f₀ or f₁ may be set according to the configuration (e.g., all intra, random access, low-delay B, low-delay P, etc.).
k. In one example, the same rule of usage of NN filtering should be applied to calculate RD costs for all candidate modes and/or partitioning methods for a block.

2. Whether to and/or how to utilize the NN filter models (or calculate the rate distortion cost) in RDO process may be dependent on the distortion D_{ORG} without NN filter model and/or the combination of distortions with multiple NN filter models. The RDO criterion is noted as J=D+lambda*R.
a. In one example, D in RDO criterion is the minimal value of distortions with m NN filter models.
   i. In one example, m is the available number of constructed NN filter models.
   ii. In one example, m is dependent on the type of video unit.
   iii. In one example, m is dependent on the signaled parameters of video unit.
   iv. In one example, m is the default value.
   v. In one example, m is 0, 1, 2, 3, 4, etc.
b. In one example, D in RDO criterion is the minimal value of the distortion without NN filter model and distortions with m NN filter models.
   i. In one example, m is the available number of constructed NN filter models.
   ii. In one example, m is dependent on the type of video unit.
   iii. In one example, m is dependent on the signaled parameters of video unit.
   iv. In one example, m is the default value.
   v. In one example, m is 0, 1, 2, 3, 4, etc.
c. In one example, D in RDO criterion is combination of the distortion without NN filter model and distortions with m NN filter models.
   i. In one example, D=f₀*D_{ORG}+Σfₙ*Dⁿ_{NNLF}.
d. In the above inventions, the parameters m or f₀ or fₙ may be set according to the temporal layers and/or slice types.
e. In the above inventions, the parameters m or f₀ or fₙ may be set according to the QP (quantization parameter).
f. In one example, the same rule of usage of NN filtering should be applied to calculate RD costs for all candidate modes and/or partitioning methods for a block.

3. The distortion D_{ORG} without NN filter model may be dependent on the other filters LFⁱ which are different with the NN filtering models (e.g., Deblocking, ALF). The distortion Dⁱ_{LF} with LFⁱ may mean that the reconstruction samples are filtered by the LFⁱ filter and the filtered reconstruction samples will be compared with the original samples to derive the distortion.
a. In one example, the LFⁱ may be applied on the reconstruction samples before NN filtering models.
b. In one example, the NN filtering models may be applied after LFⁱ.
c. In one example, D_{ORG} is a scaled version of the distortion Dⁱ_{LF} with filter LFⁱ, i.e., D_{ORG}=f*D_{LF}.
d. In one example, D_{ORG} is the combination of the distortions with multiple of other filters, i.e.,

$${D}_{ORG} = \sum {f}_{i} * {D}_{LF}^{i} .$$

### On Implementation of the NN Filter Models in the RDO Process

4. The input of the NN filter models in RDO process may include the signal from the current video block and/or the neighboring blocks.
a. In one example, the prediction signal and/or partitioning information and/or reconstruction signal from the current block may be involved in the NN filter process.
b. In one example, other information from one/multiple reference frames may be involved in the NN filter process of current block.
   i. In one example, the collocated block from the first frame in list-0 and/or the collocated block from the first frame in list-1 may be involved in the NN filter process.
   ii. In one example, one/multiple motion compensated reference blocks may be involved in the NN filter process.
c. In one example, the prediction signal and/or partitioning information and/or pixels from at least one neighboring block may be involved in the NN filter process.
   i. In one example, the neighboring blocks may be located at the left or above or left-above side of the current block.
   ii. In one example, the samples of neighboring blocks may be reconstructed.
   iii. In one example, the neighboring blocks may be located at the right or below side of the current block.
   iv. In one example, the samples of neighboring blocks may not be reconstructed.
   v. In one example, the samples of neighboring blocks may be original signal.
   vi. In one example, the samples of neighboring blocks may be derived from the current block.
d. In one example, these above inventions could be combined in any manner.

### On Usage of the NN Filter Models in the RDO Process

5. Whether to and/or how to utilize the NN filter models in RDO process may be dependent on the coding statistics of the video unit (e.g., prediction modes, qp, temporal layer, slice type, etc.).
a. Whether to and/or how to utilize the NN filter models in RDO process may be dependent on the dimension of the video unit.
   i. In one example, when W<=T1 and/or H<=T2 (e.g., T1=T2=64), the NN filter models may be utilized in the RDO process.
   ii. In one example, when W>=T1 and/or H>=T2 (e.g., T1=T2=16), the NN filter models may be utilized in the RDO process.
   iii. In one example, when W*H>=T1 (e.g., T1=64), the NN filter models may be utilized in the RDO process.
   iv. In one example, when W*H<=T1 (e.g., T1=4096), the NN filter models may be utilized in the RDO process.
b. Whether to and/or how to utilize the NN filter models in RDO process may be dependent on the color components.
   i. In one example, the NN filter models is only applied in the component X.
      1) In one example, X is Luma (Y) or Chroma (Cb or Cr).
   ii. In one example, the NN filter models is applied for all color components.
c. Whether to and/or how to utilize the NN filter models in RDO process may be dependent on the rate distortion cost without NN filter model. J_{A} means the cost of mode A without NN filter model and J_{B} means the cost of mode B without NN filter model.
   i. In one example, NN filter models may be not applied when the cost J_{A} is greater than and/or equal than multiple of cost J_{B} (J_{A}>f₀*J_{B} or J_{A}>=f₀*J_{B}).
      1) In one example, f₀ is 1.0, 1.001, 1.005, 1.05, 1.01.
   ii. In one example, NN filter models may be not applied when the cost J_{B} is greater than and/or equal than multiple of cost J_{A} (J_{B}>f₁*J_{A} or J_{B}>=f₁*J_{A}).
      1) In one example, f₁ is 1.0, 1.001, 1.005, 1.05, 1.01.
   iii. In one example, J_{A}>f₀*J_{B} J_{B}>f*J_{A}.
   iv. In one example, NN filter models may be not applied when the ratio between cost J_{A} and cost J_{B} is greater than and/or equal than a threshold (J_{A}/J_{B}>f₂ or J_{A}/J_{B}>=f₂).
      1) In one example, f₂ is 1.0, 1.001, 1.005, 1.05, 1.01.
   v. In one example, NN filter models may be not applied when the ratio between cost J_{A} and cost J_{B} is smaller than and/or equal than a threshold (J_{A}/J_{B} f₃ or J_{A}/J_{B}<=f₃).
      1) In one example, f₃ is 1.0, 1.001, 1.005, 1.05, 1.01.
   vi. In one example, J_{A}/J_{B}>f₂∥J_{A}/J_{B} f₃.
   vii. In one example, NN filter models may be NOT or be applied when the cost J_{A} is equal or/and smaller or/and greater than a threshold Th_{A} and/or the cost J_{B} is equal or/and smaller or/and greater than a threshold Th_{B}.
      1) In one example, Th_{A} or Th_{B} is equal to MAX_DOUBLE which is a default value.
      2) In one example, Th_{A} or Th_{B} is equal to 1.7e+308.
   viii. In one example, the NN filter for mode A and mode B may be applied according to the certain or adaptive order.
      1) In one example, the order of applying the NN filter for mode A and mode B may be dependent on the coding modes/statistics of the video unit (e.g., prediction modes, qp, temporal layer, slice type, etc.).
      2) In one example, the order of applying the NN filter for mode A and mode B may be dependent on J_{A} and J_{B}.
         a. In one example, when J_{A} is greater than and/or equal than J_{B}, applying the NN filter for mode A may have a greater priority than applying the NN filter for mode B.
         b. In one example, when J_{B} is greater than and/or equal than J_{A}, applying the NN filter for mode A may have a greater priority than applying the NN filter for mode B.
   ix. In one example, J_{A} may be equal to D+lambda*R.
      1) In one example, D may be equal to D_{ORG}.
   x. In one example, J_{B} may be equal to D+lambda*R.
      1) In one example, D may be equal to D_{ORG}.
   xi. In one example, these above inventions could be combined in any manner.
   xii. In the above inventions, the parameters Th_{A}, Th_{B}, f₀, f₁, f₂, or f₃ may be set according to the temporal layers.
   xiii. In the above inventions, the parameters Th_{A}, Th_{B}, f₀, f₁, f₂, or f₃ may be set according to the QP (quantization parameter).
   xiv. In the above inventions, the parameters Th_{A}, Th_{B}, f₀, f₁, f₂, or f₃ may be set according to the slice type.
   xv. In the above inventions, the parameters Th_{A}, Th_{B}, f₀, f₁, f₂, or f₃ may be set according to the configuration (e.g., all intra, random access, low-delay B, low-delay P, etc.).
d. Whether to and/or how to utilize the NN filter models in RDO process may be dependent on the rate distortion cost without NN filter model and the rate distortion cost with NN filter model. J_{A} means the cost of mode A without NN filter model and J′_{B} means the cost of mode B with NN filter model.
   i. In one example, whether to apply NN filter models for mode A may be dependent on the cost J_{A} and J′_{B}.
   ii. In one example, J_{A} may be equal to D+lambda*R.
      1) In one example, D may be equal to D_{ORG}.
   iii. In one example, J′_{B} may be equal to D+lambda*R.
      1) In one example, D may be equal to min(Dⁿ_{NNLF}, D_{ORG}).
      2) In one example, D may be equal to Dⁿ_{NNLF}.
   iv. In one example, NN filter models may be not applied for mode A when the cost J_{A} is greater than and/or equal than multiple of cost J′_{B} (J_{A}>f₀*J′_{B} or J_{A}>=f₀*J_{B}).
   v. In one example, NN filter models may be not applied for mode A when the cost J′_{B} is greater than and/or equal than multiple of cost J_{A} (J′_{B}>f₁*J_{A} or J′_{B}>=f₁*J_{A}).
   vi. In one example, J_{A}>f₀*J′_{B}∥J_{B}>f₁*J_{A}.
   vii. In one example, NN filter models may be not applied when the ratio between cost J_{A} and cost J′_{B} is greater than and/or equal than a threshold (J_{A}/J′_{B}>f₂ or J_{A}/J′_{B}>=f₂).
   viii. In one example, NN filter models may be not applied when the ratio between cost J_{A} and cost J′_{B} is smaller than and/or equal than a threshold (J_{A}/J′_{B}>f₃ or J_{A}/J′_{B}<=f₃).
   ix. In one example, J_{A}/J′_{B}>f₂∥J_{A}/J′_{B}>f₃.
   x. In one example, these above inventions could be combined in any manner.
   xi. In the above inventions, the parameters f₀, f₁, f₂, or f₃ may be set according to the temporal layers.
   xii. In the above inventions, the parameters f₀, f₁, f₂, or f₃ may be set according to the QP (quantization parameter).
   xiii. In the above inventions, the parameters f₀, f₁, f₂, or f₃ may be set according to the slice type.
   xiv. In the above inventions, the parameters f₀, f₁, f₂, or f₃ may be set according to the configuration (e.g., all intra, random access, low-delay B, low-delay P, etc).
e. In one example, NN filtering may only be applied to partial samples of a block in the RDO process.
   i. For example, NN filtering may only be applied to the center W1×H1 subblock in a W×H block.
      1) For example, W1=W/2, H1=H/2.
      2) For example, W1=3*W/4, H1=3*H/4.
f. Whether to and/or how to utilize the NN filter models in RDO process may be dependent on the temporal layers.
   i. In one example, NN filter models may be applied to temporal layers with ID greater than K.
      1) In one example, K is equal to 0,1,2,3,4,5,6.
   ii. In one example, NN filter models may be applied to temporal layers with ID smaller than K.
      1) In one example, K is equal to 0,1,2,3,4,5,6.
g. Whether to and/or how to utilize the NN filter models in RDO process may be dependent on the coding statistics of sub coding units.
   i. In one example, NN filter models may be NOT or be applied for the current block when NN filter models are applied to part or all of sub coding units.
   ii. In one example, NN filter models may be NOT or be applied for the current block when rate-distortion costs and/or the distortions of part or all of sub coding units are available.

### 5. EMBODIMENT

### 5.1. Embodiment #1

In this implementation, the convolutional neural network-based in-loop filtering with adaptive model selection (DAM) is extended to the rate distortion optimization (RDO) process. And the number of residual blocks in DAM is reduced to 4. The DAM is applied to the coding unit level to select the best partitioning structure based on the RDO criterion. The rate distortion cost could be formulated as:

$$J = D + lambda * R$$

where D denotes the minimum value of distortion with DAM and without DAM.

Before applying the DAM, the cost J_{A} of partitioning mode A and the cost J_{B} of partitioning mode B are checked. When meeting the following condition, the DAM is skipped.

$${J}_{A} > {f}_{0} * {J}_{B} ‖ {J}_{B} > {f}_{1} * {J}_{A}$$

Where the f₀ and f₁ are parameters.

The embodiments of the present disclosure are related to RDO process with machine learning model. As used herein, the term “machine learning model” can also be referred to as a “machine learning model”. The machine learning model may comprise any kinds of model, such as a neural network (NN) model (also referred to as a “NN filter” or “NN filter model”), a convolutional neural network (CNN) model, or the like. Alternatively, in some embodiments, the machine learning model further comprises non-NN based models or non-NN based filters. Scope of the present disclosure is not limited in this regard.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. As used herein, the term “father video unit” may represent a unit larger than the video unit. A father unit will contain several video units. For example, if the video unit is a CTU, the father unit may be a slice, CTU row, multiple CTUs, etc.

FIG. 16 illustrates a flowchart of a method 1600 for video processing in accordance with some embodiments of the present disclosure. The method 1600 may be implemented for a conversion between a current video block of a video and a bitstream of the video. As used herein, the term “current video block” may also be referred to as a “target video block”.

As shown in FIG. 16, at block 1610, a distortion value of the current video block is determined based on a set of distortion metrics. The set of distortion metrics comprises at least one of: a first distortion metric determined according to a first machine learning model, a second distortion metric determined according to a second machine learning model, or a third distortion metric determined without using the first and second machine learning models.

The method 1600 enables determining a distortion value of the current video block based on a set of distortion metrics. The determined distortion value may be applied in a rate-distortion optimization (RDO) process, and thus can improve the RDO process. In this way, the coding effectiveness and coding efficiency can be improved.

At block 1620, the conversion is performed based on the distortion metric. In some embodiments, the conversion may include encoding the current video block into the bitstream. Alternatively, or in addition, the conversion may include decoding the current video block from the bitstream.

In some embodiments, at block 1610, if the first machine learning model is applied for at least one of a plurality of candidate modes of the current video block, the first distortion metric may be determined as the distortion value. In some embodiments, at block 1610, if the first machine learning model is not applied for at least one of the plurality of candidate modes of the current video block, the third distortion metric may be determined as the distortion value.

In some embodiments, the plurality of candidate modes are not partitioning modes. That is, if all or one of T candidate modes are not partitioning modes, the distortion value in RDO criterion may be a combination of the distortion with a model such as a NN filter model and a distortion without the NN filter model.

In some embodiments, when all or one of T candidate modes are not partitioning modes, the distortion value D in RDO criterion is combination of the distortion with the p^{th} machine learning model such as a NN filter model and/or distortion without the machine learning model. If a p^{th} NN filter model is not applied for one or all of T candidate modes, D in RDO criterion is the distortion without NN filter model (D=D_{ORG}). If the p^{th} NN filter model is applied for all or one of T candidate modes, D in RDO criterion is the distortion with the p^{th} NN filter model (D=D^{p}_{NNLF}).

In some embodiments, at block 1610, if the second machine learning model is applied for at least one of a plurality of candidate modes of the current video block, a minimum one of the second and third distortion metrics may be determined as the distortion value. In some embodiments, at block 1610, if the second machine learning model is not applied for at least one of the plurality of candidate modes of the current video block, the distortion value may be determined based on the first and third distortion metrics.

In some embodiments, if the first machine learning model is applied to the plurality of candidate modes, the first distortion metric may be determined as the distortion value. In some embodiments, if the first machine learning model is not applied to the plurality of candidate modes, the third distortion metric may be determined as the distortion value.

In some embodiments, at block 1610, the distortion value may be determined based on a combination of the set of distortion metrics. The combination of the set of distortion metrics may be determined based on at least one of the following: coding statistics of the current video block, a first usage of the first machine learning model, a second usage of the second machine learning model, or a priority order of the set of distortion metrics.

In some embodiments, the method 1600 further comprises: determining the priority order based on at least one of the following: a coding mode of the current video block, or coding statistics of the current video block.

In some embodiments, the coding statistics comprises at least one of the following: a prediction mode of the current video block, a type of the prediction mode, a quantization parameter (QP) of the current video block, a temporal layer of the current video block, or a slice type of the current video block.

In some embodiments, a fourth distortion metric comprises a minimum one of the second and third distortion metrics, a priority of the fourth distortion metric is higher than a priority of the first distortion metric. That is, a minimum one D=min(D^{q}_{NNLF}, D_{ORG}) may have a greater priority than the distortion with the p^{th} NN filter model D=D^{p}_{NNLF}.

In some embodiments, a priority of the first distortion metric is higher than a priority of the third distortion metric. That is, the distortion with the p^{th} NN filter model D=D^{p}_{NNLF} may have a greater priority than the distortion without NN filter model D=D_{ORG}.

In some embodiments, a plurality of candidate modes of the current video block are partitioning modes, and the combination of the set of distortion metric comprises the first, the second and the third distortion metric.

In some embodiments, the first machine learning model comprises one of the following: a deblocking filter, a sample adaptive offset (SAO), or an adaptive loop filer (ALF).

In some embodiments, the second machine learning model comprises a convolutional neural network (CNN) model.

In some embodiments, the first machine learning model is the same with the second machine learning model.

In some embodiments, a first index of the first machine learning model is the same with a second index of the second machine learning model.

In some embodiments, the method 1600 further comprises: performing, based on the distortion value, a rate-distortion optimization (RDO) process on the current video block.

In some embodiments, the RDO process may be performed on a plurality of candidate modes based on a rate-distortion cost. The rate-distortion cost may be determined based on a sum of the distortion value and a weighted rate of the current video block.

In some embodiments, a number of the plurality of candidate modes comprises one of: 1, 2, 3 or 4.

In some embodiments, the rate-distortion cost may be determined by using the following: J=D+lambda*R (referred to as the RDO criterion), where J represents the rate-distortion cost, D represents the distortion value, R represents a rate of the current video block, and lambda represents a predefined factor.

In some embodiments, a target coding tool of the current video block may be determined based on the rate-distortion cost. As used herein, the term “target coding tool” may represent a coding tool to be used on the current video block during the conversion. The coding tool may be a coding mode or a coding method.

In some embodiments, the set of distortion metrics further comprises at least one of the following: a minimum one of the third distortion metric and a fifth distortion metric determined according to one of a plurality of machine learning models, the plurality of machine learning models comprising the first and second machine learning models, a sixth distortion metric determined according to a predefined or selected model of the plurality of machine learning models, a scaled metric of the third distortion metric, or a weighted sum of the first, second, third, fifth or sixth metric.

According to further embodiments of the present disclosure, a non-transitory computer-readable recording medium is provided. The non-transitory computer-readable recording medium stores a bitstream of a video which is generated by a method performed by an apparatus for video processing. According to the method, a distortion value of a current video block of the video is determined based on a set of distortion metrics. The set of distortion metrics comprise at least one of: a first distortion metric determined according to a first machine learning model, a second distortion metric determined according to a second machine learning model, or a third distortion metric determined without using the first and second machine learning models. The bitstream is generated based on the distortion value.

According to still further embodiments of the present disclosure, a method for storing bitstream of a video is provided. According to the method, a distortion value of a current video block of the video is determined based on a set of distortion metrics. The set of distortion metrics comprise at least one of: a first distortion metric determined according to a first machine learning model, a second distortion metric determined according to a second machine learning model, or a third distortion metric determined without using the first and second machine learning models. The bitstream is generated based on the distortion value. The bitstream is stored in a non-transitory computer-readable recording medium.

According to embodiments of the present disclosure, the distortion value may be determined based on a set of distortion metrics. The determined distortion value can be applied in a RDO process. In this way, the RDO process can be improved, and thus the coding effectiveness and coding efficiency may be improved.

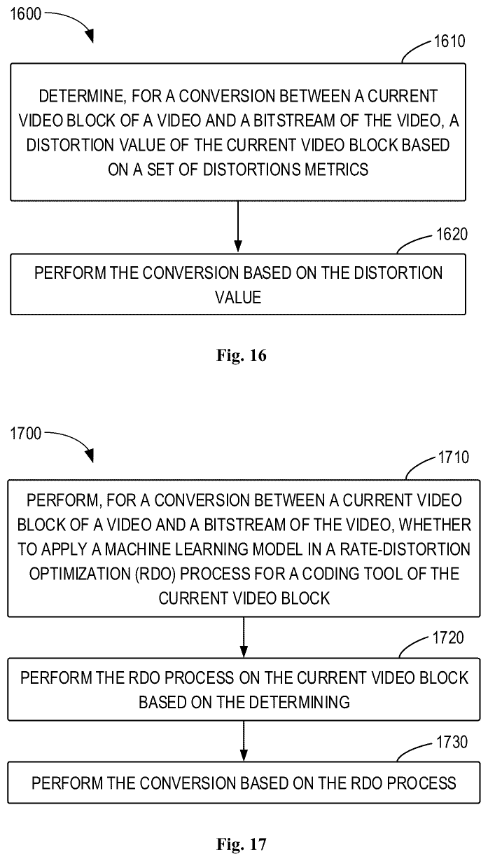

FIG. 17 illustrates a flowchart of a method 1700 for video processing in accordance with some embodiments of the present disclosure. The method 1700 may be implemented for a conversion between a current video block of a video and a bitstream of the video. As shown in FIG. 17, at block 1710, whether to apply a machine learning model in a rate-distortion optimization (RDO) process for a coding tool of the current video block is determined. At block 1720, the RDO process is performed on the current video block based on the determining.

At block 1730, the conversion is performed based on the RDO process. In some embodiments, the conversion may include encoding the current video block into the bitstream. Alternatively, or in addition, the conversion may include decoding the current video block from the bitstream.

By using the method 1700, whether to apply a machine learning model in a RDO process for a coding tool of the current video block can be determined. In this way, the coding effectiveness and coding efficiency can be improved.

As used herein, the term a “coding tool” or a “target coding tool” may represent a coding tool to be used on the current video block during the conversion. The coding tool may be a coding mode or a coding method.

In some embodiments, at block 1710, a priority order of the coding tool and a further coding tool may be determined. Whether to apply the machine learning model in the RDO process for the coding tool or for the further coding tool may be determined based on the priority order.

In some embodiments, if the priority order indicates a first priority of the coding tool being higher than or equal to a second priority of the further coding tool, it is determined to apply the machine learning model in the RDO process for the coding tool. Alternatively, or in addition, in some embodiments, if the priority order indicates the first priority of the coding tool being lower than the second priority of the further coding tool, it is determined to apply the machine learning model in the RDO process for the further coding tool.

In some embodiments, if a first rate-distortion cost of the coding tool is greater than or equal to a second rate-distortion cost of the further coding tool, a first priority of the coding tool may be determined to be higher than a second priority of the further coding tool. The first and second rate-distortion costs are determined without using the machine learning model.

In some embodiments, if a first rate-distortion cost of the coding tool is less than or equal to a second rate-distortion cost of the further coding tool, a first priority of the coding tool may be determined to be higher than a second priority of the further coding tool. The first and second rate-distortion costs are determined without using the machine learning model.

In some embodiments, the first or second rate-distortion cost is determined based on a sum of a distortion value of the current video block and a weighted rate of the current video block.

In some embodiments, the distortion value of the current video block comprises a first distortion value determined without using the machine learning model.

In some embodiments, the priority order may be determined based on at least one of a coding mode of the current video block or coding statistics of the current video block.

In some embodiments, the coding statistics comprises at least one of the following: a prediction mode of the current video block, a type of the prediction mode, a quantization parameter (QP) of the current video block, a temporal layer of the current video block, or a slice type of the current video block.

In some embodiments, at block 1710, whether to apply the machine learning model in the RDO process for the coding tool may be determined based on a first rate-distortion cost of the coding tool and a second rate-distortion cost of a further coding tool. The first rate-distortion cost is determined without using the machine learning model. The second rate-distortion cost is determined according to the machine learning model.

In some embodiments, the first rate-distortion cost is determined based on a sum of a first distortion value of the current video block and a weighted rate of the current video block.

In some embodiments, the first distortion value of the current video block is determined without using the machine learning model.

In some embodiments, the second rate-distortion cost is determined based on a sum of a second distortion value of the current video block and a weighted rate of the current video block.

In some embodiments, the second distortion value of the current video block comprises one of the following: a minimum one of a first distortion value determined without using the machine learning model and a third distortion value determined according to the machine learning model, or the first distortion value.

In some embodiments, the first or second rate-distortion cost may be determined by using the following: J=D+lambda*R, where J represents the rate-distortion cost, D represents the first or second distortion value, R represents a rate of the current video block, and lambda represents a predefined factor.

In some embodiments, the machine learning model comprises at least one of: a neural network (NN) model, a convolutional neural network (CNN) model, or a non-NN based model.

According to further embodiments of the present disclosure, a non-transitory computer-readable recording medium is provided. The non-transitory computer-readable recording medium stores a bitstream of a video which is generated by a method performed by an apparatus for video processing. According to the method, whether to apply a machine learning model in a rate-distortion optimization (RDO) process for a coding tool of a current video block of the video is determined. The RDO process is performed on the current video block based on the determining. The bitstream is generated based on the RDO process.

According to still further embodiments of the present disclosure, a method for storing bitstream of a video is provided. According to the method, whether to apply a machine learning model in a rate-distortion optimization (RDO) process for a coding tool of a current video block of the video is determined. The RDO process is performed on the current video block based on the determining. The bitstream is generated based on the RDO process. The bitstream is stored in a non-transitory computer-readable recording medium.

According to embodiments of the present disclosure, whether to apply a machine learning model in a RDO process for a coding tool can be determined. In this way, the RDO process for the coding tool can be enhanced, and thus the coding effectiveness and coding efficiency can be improved.

It is to be understood that the above method 1600 and/or method 1700 may be used in combination or separately. Any suitable combination of these methods may be applied. Scope of the present disclosure is not limited in this regard.

By using these methods 1600 and/or 1700 separately or in combination, the RDO process can be improved. In this way, the coding effectiveness and coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, a distortion value of the current video block based on a set of distortion metrics, the set of distortion metrics comprising at least one of: a first distortion metric determined according to a first machine learning model, a second distortion metric determined according to a second machine learning model, or a third distortion metric determined without using the first and second machine learning models; and performing the conversion based on the distortion value.

Clause 2. The method of clause 1, wherein determining the distortion value comprises: in accordance with a determination that the first machine learning model is applied for at least one of a plurality of candidate modes of the current video block, determining the first distortion metric as the distortion value; and in accordance with a determination that the first machine learning model is not applied for at least one of the plurality of candidate modes of the current video block, determining the third distortion metric as the distortion value.

Clause 3. The method of clause 2, wherein the plurality of candidate modes are not partitioning modes.

Clause 4. The method of any of clauses 1-3, wherein determining the distortion value comprises: in accordance with a determination that the second machine learning model is applied for at least one of a plurality of candidate modes of the current video block, determining a minimum one of the second and third distortion metrics as the distortion value; and in accordance with a determination that the second machine learning model is not applied for at least one of the plurality of candidate modes of the current video block, determining the distortion value based on the first and third distortion metrics.

Clause 5. The method of clause 4, wherein determining the distortion value based on the first and third distortion metrics comprises: in accordance with a determination that the first machine learning model is applied to the plurality of candidate modes, determining the first distortion metric as the distortion value; and in accordance with a determination that the first machine learning model is not applied to the plurality of candidate modes, determining the third distortion metric as the distortion value.

Clause 6. The method of any of clauses 1-5, wherein determining the distortion value comprises: determining the distortion value based on a combination of the set of distortion metrics, the combination of the set of distortion metrics being determined based on at least one of the following: coding statistics of the current video block, a first usage of the first machine learning model, a second usage of the second machine learning model, or a priority order of the set of distortion metrics.

Clause 7. The method of clause 6, further comprising: determining the priority order based on at least one of the following: a coding mode of the current video block, or coding statistics of the current video block.

Clause 8. The method of clause 6 or clause 7, wherein the coding statistics comprises at least one of the following: a prediction mode of the current video block, a type of the prediction mode, a quantization parameter (QP) of the current video block, a temporal layer of the current video block, or a slice type of the current video block.

Clause 9. The method of any of clauses 6-8, wherein a fourth distortion metric comprises a minimum one of the second and third distortion metrics, a priority of the fourth distortion metric is higher than a priority of the first distortion metric.

Clause 10. The method of any of clauses 6-9, wherein a priority of the first distortion metric is higher than a priority of the third distortion metric.

Clause 11. The method of any of clauses 6-10, wherein a plurality of candidate modes of the current video block are partitioning modes, and the combination of the set of distortion metric comprises the first, the second and the third distortion metric.

Clause 12. The method of any of clauses 1-11, wherein the first machine learning model comprises one of the following: a deblocking filter, a sample adaptive offset (SAO), or an adaptive loop filer (ALF).

Clause 13. The method of any of clauses 1-12, wherein the second machine learning model comprises a convolutional neural network (CNN) model.

Clause 14. The method of any of clauses 1-13, wherein the first machine learning model is the same with the second machine learning model.

Clause 15. The method of any of clauses 1-14, wherein a first index of the first machine learning model is the same with a second index of the second machine learning model.

Clause 16. The method of any of clauses 1-15, further comprising: performing, based on the distortion value, a rate-distortion optimization (RDO) process on the current video block.

Clause 17. The method of clause 16, wherein performing the RDO process on the current video block comprises: performing the RDO process on a plurality of candidate modes based on a rate-distortion cost, wherein the rate-distortion cost is determined based on a sum of the distortion value and a weighted rate of the current video block.

Clause 18. The method of clause 17, wherein a number of the plurality of candidate modes comprises one of: 1, 2, 3 or 4.

Clause 19. The method of any of clauses 1-18, wherein the set of distortion metrics further comprises at least one of the following: a minimum one of the third distortion metric and a fifth distortion metric determined according to one of a plurality of machine learning models, the plurality of machine learning models comprising the first and second machine learning models, a sixth distortion metric determined according to a predefined or selected model of the plurality of machine learning models, a scaled metric of the third distortion metric, or a weighted sum of the first, second, third, fifth or sixth metric.

Clause 20. A method for video processing, comprising: determining, for a conversion between a current video block of a video and a bitstream of the video, whether to apply a machine learning model in a rate-distortion optimization (RDO) process for a coding tool of the current video block; performing the RDO process on the current video block based on the determining; and performing the conversion based on the RDO process.

Clause 21. The method of clause 20, wherein determining whether to apply the machine learning model in the RDO process for the coding tool comprises: determining a priority order of the coding tool and a further coding tool; and determining whether to apply the machine learning model in the RDO process for the coding tool or for the further coding tool based on the priority order.

Clause 22. The method of clause 21, wherein determining whether to apply the machine learning model in the RDO process for the coding tool or for the further coding tool based on the priority order comprises: in accordance with a determination that the priority order indicating a first priority of the coding tool being higher than or equal to a second priority of the further coding tool, determining to apply the machine learning model in the RDO process for the coding tool; and in accordance with a determination that the priority order indicating the first priority of the coding tool being lower than the second priority of the further coding tool, determining to apply the machine learning model in the RDO process for the further coding tool.

Clause 23. The method of clause 21 or clause 22, wherein determining the priority order comprises: in accordance with a determination that a first rate-distortion cost of the coding tool is greater than or equal to a second rate-distortion cost of the further coding tool, determining that a first priority of the coding tool is higher than a second priority of the further coding tool, the first and second rate-distortion costs being determined without using the machine learning model.

Clause 24. The method of clause 21 or clause 22, wherein determining the priority order comprises: in accordance with a determination that a first rate-distortion cost of the coding tool is less than or equal to a second rate-distortion cost of the further coding tool, determining that a first priority of the coding tool is higher than a second priority of the further coding tool, the first and second rate-distortion costs being determined without using the machine learning model.

Clause 25. The method of clause 23 or clause 24, wherein the first or second rate-distortion cost is determined based on a sum of a distortion value of the current video block and a weighted rate of the current video block.

Clause 26. The method of clause 25, wherein the distortion value of the current video block comprises a first distortion value determined without using the machine learning model.

Clause 27. The method of any of clauses 21-26, wherein determining the priority order comprises: determining the priority order based on at least one of a coding mode of the current video block or coding statistics of the current video block.

Clause 28. The method of clause 27, wherein the coding statistics comprises at least one of the following: a prediction mode of the current video block, a type of the prediction mode, a quantization parameter (QP) of the current video block, a temporal layer of the current video block, or a slice type of the current video block.

Clause 29. The method of any of clauses 20-28, wherein determining whether to apply the machine learning model in the RDO process for the coding tool comprises: determining whether to apply the machine learning model in the RDO process for the coding tool based on a first rate-distortion cost of the coding tool and a second rate-distortion cost of a further coding tool, the first rate-distortion cost being determined without using the machine learning model, the second rate-distortion cost being determined according to the machine learning model.

Clause 30. The method of clause 29, wherein the first rate-distortion cost is determined based on a sum of a first distortion value of the current video block and a weighted rate of the current video block.

Clause 31. The method of clause 30, wherein the first distortion value of the current video block is determined without using the machine learning model.

Clause 32. The method of any of clauses 29-31, wherein the second rate-distortion cost is determined based on a sum of a second distortion value of the current video block and a weighted rate of the current video block.

Clause 33. The method of clause 32, wherein the second distortion value of the current video block comprises one of the following: a minimum one of a first distortion value determined without using the machine learning model and a third distortion value determined according to the machine learning model, or the first distortion value.

Clause 34. The method of any of clauses 20-33, wherein the machine learning model comprises at least one of: a neural network (NN) model, a convolutional neural network (CNN) model, or a non-NN based model.

Clause 35. The method of any of clauses 1-34, wherein the conversion includes encoding the current video block into the bitstream.

Clause 36. The method of any of clauses 1-34, wherein the conversion includes decoding the current video block from the bitstream.

Clause 37. An apparatus for video processing comprising a processor and a non-transitory memory with instructions thereon, wherein the instructions upon execution by the processor, cause the processor to perform a method in accordance with any of clauses 1-36.

Clause 38. A non-transitory computer-readable storage medium storing instructions that cause a processor to perform a method in accordance with any of clauses 1-36.

Clause 39. A non-transitory computer-readable recording medium storing a bitstream of a video which is generated by a method performed by an apparatus for video processing, wherein the method comprises: determining a distortion value of a current video block of the video based on a set of distortion metrics, the set of distortion metrics comprising at least one of: a first distortion metric determined according to a first machine learning model, a second distortion metric determined according to a second machine learning model, or a third distortion metric determined without using the first and second machine learning models; and generating the bitstream based on the distortion value.

Clause 40. A method for storing a bitstream of a video, comprising: determining a distortion value of a current video block of the video based on a set of distortion metrics, the set of distortion metrics comprising at least one of: a first distortion metric determined according to a first machine learning model, a second distortion metric determined according to a second machine learning model, or a third distortion metric determined without using the first and second machine learning models; generating the bitstream based on the distortion value; and storing the bitstream in a non-transitory computer-readable recording medium.

Clause 41. A non-transitory computer-readable recording medium storing a bitstream of a video which is generated by a method performed by an apparatus for video processing, wherein the method comprises: determining whether to apply a machine learning model in a rate-distortion optimization (RDO) process for a coding tool of a current video block of the video; performing the RDO process on the current video block based on the determining; and generating the bitstream based on the RDO process.

Clause 42. A method for storing a bitstream of a video, comprising: determining whether to apply a machine learning model in a rate-distortion optimization (RDO) process for a coding tool of a current video block of the video; performing the RDO process on the current video block based on the determining; generating the bitstream based on the RDO process; and storing the bitstream in a non-transitory computer-readable recording medium.

### Example Device

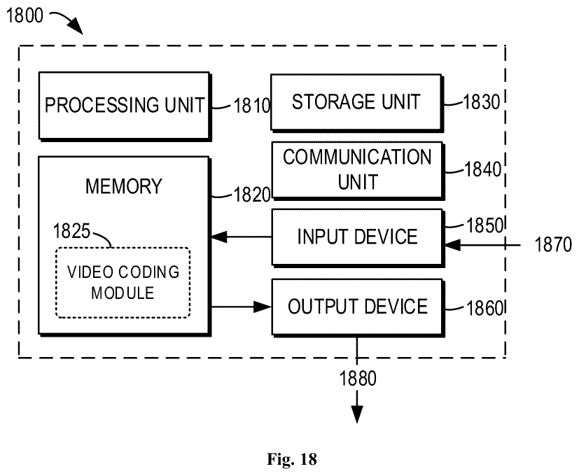

FIG. 18 illustrates a block diagram of a computing device 1800 in which various embodiments of the present disclosure can be implemented. The computing device 1800 may be implemented as or included in the source device 110 (or the video encoder 114 or 200) or the destination device 120 (or the video decoder 124 or 300).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement video encoding/decoding in embodiments of the present disclosure. The memory 1820 may include one or more video coding modules 1825 having one or more program instructions. These modules are accessible and executable by the processing unit 1810 to perform the functionalities of the various embodiments described herein.

In the example embodiments of performing video encoding, the input device 1850 may receive video data as an input 1870 to be encoded. The video data may be processed, for example, by the video coding module 1825, to generate an encoded bitstream. The encoded bitstream may be provided via the output device 1860 as an output 1880.

In the example embodiments of performing video decoding, the input device 1850 may receive an encoded bitstream as the input 1870. The encoded bitstream may be processed, for example, by the video coding module 1825, to generate decoded video data. The decoded video data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a distortion value of the current video block based on a set of distortion metrics, the set of distortion metrics comprising at least one of:
a first distortion metric determined according to a first machine learning model,
a second distortion metric determined according to a second machine learning model, or
a third distortion metric determined without using the first and second machine learning models; and
performing the conversion based on the distortion value.

2. The method of claim 1, wherein determining the distortion value comprises:
in accordance with a determination that the first machine learning model is applied for at least one of a plurality of candidate modes of the current video block, determining the first distortion metric as the distortion value; and
in accordance with a determination that the first machine learning model is not applied for at least one of the plurality of candidate modes of the current video block, determining the third distortion metric as the distortion value,
wherein the plurality of candidate modes are not partitioning modes.

3. The method of claim 1, wherein determining the distortion value comprises:
in accordance with a determination that the second machine learning model is applied for at least one of a plurality of candidate modes of the current video block, determining a minimum one of the second and third distortion metrics as the distortion value; and
in accordance with a determination that the second machine learning model is not applied for at least one of the plurality of candidate modes of the current video block, determining the distortion value based on the first and third distortion metrics.

4. The method of claim 3, wherein determining the distortion value based on the first and third distortion metrics comprises:
in accordance with a determination that the first machine learning model is applied to the plurality of candidate modes, determining the first distortion metric as the distortion value; and
in accordance with a determination that the first machine learning model is not applied to the plurality of candidate modes, determining the third distortion metric as the distortion value.

5. The method of claim 1, wherein determining the distortion value comprises: determining the distortion value based on a combination of the set of distortion metrics,
wherein the combination of the set of distortion metrics is determined based on at least one of:
coding statistics of the current video block,
a first usage of the first machine learning model,
a second usage of the second machine learning model, or
a priority order of the set of distortion metrics.

6. The method of claim 5, further comprising:
determining the priority order based on at least one of the following:
a coding mode of the current video block, or
coding statistics of the current video block.

7. The method of claim 5, wherein the coding statistics comprises at least one of:
a prediction mode of the current video block,
a type of the prediction mode,
a quantization parameter (QP) of the current video block,
a temporal layer of the current video block, or
a slice type of the current video block.

8. The method of claim 5, wherein a fourth distortion metric comprises a minimum one of the second and third distortion metrics, a priority of the fourth distortion metric is higher than a priority of the first distortion metric, or
wherein a priority of the first distortion metric is higher than a priority of the third distortion metric.

9. The method of claim 5, wherein a plurality of candidate modes of the current video block are partitioning modes, and
the combination of the set of distortion metric comprises the first, the second and the third distortion metric.

10. The method of claim 1, wherein the first machine learning model comprises one of the following:
a deblocking filter,
a sample adaptive offset (SAO), or
an adaptive loop filer (ALF).

11. The method of claim 1, wherein the second machine learning model comprises a convolutional neural network (CNN) model.

12. The method of claim 1, wherein the first machine learning model is the same with the second machine learning model.

13. The method of claim 1, wherein a first index of the first machine learning model is the same with a second index of the second machine learning model.

14. The method of claim 1, further comprising:
performing, based on the distortion value, a rate-distortion optimization (RDO) process on the current video block,
wherein performing the RDO process on the current video block comprises:
performing the RDO process on a plurality of candidate modes based on a rate-distortion cost, wherein the rate-distortion cost is determined based on a sum of the distortion value and a weighted rate of the current video block,
wherein a number of the plurality of candidate modes comprises one of: 1, 2, 3 or 4.

15. The method of claim 1, wherein the set of distortion metrics further comprises at least one of the following:
a minimum one of the third distortion metric and a fifth distortion metric determined according to one of a plurality of machine learning models, the plurality of machine learning models comprising the first and second machine learning models,
a sixth distortion metric determined according to a predefined or selected model of the plurality of machine learning models,
a scaled metric of the third distortion metric, or
a weighted sum of the first, second, third, fifth or sixth metric.

16. The method of claim 1, wherein the conversion includes encoding the current video block into the bitstream.

17. The method of claim 1, wherein the conversion includes decoding the current video block from the bitstream.

18. An apparatus for processing video data comprising a processor and a non-transitory memory with instructions thereon, wherein the instructions upon execution by the processor, cause the processor to:
determine, for a conversion between a current video block of a video and a bitstream of the video, a distortion value of the current video block based on a set of distortion metrics, the set of distortion metrics comprising at least one of:
a first distortion metric determined according to a first machine learning model,
a second distortion metric determined according to a second machine learning model, or
a third distortion metric determined without using the first and second machine learning models; and
perform the conversion based on the distortion value.

19. A non-transitory computer-readable storage medium storing instructions that cause a processor to:
determine, for a conversion between a current video block of a video and a bitstream of the video, a distortion value of the current video block based on a set of distortion metrics, the set of distortion metrics comprising at least one of:
a first distortion metric determined according to a first machine learning model,
a second distortion metric determined according to a second machine learning model, or
a third distortion metric determined without using the first and second machine learning models; and
perform the conversion based on the distortion value.

20. A non-transitory computer-readable recording medium storing a bitstream of a video which is generated by a method performed by a video processing apparatus, wherein the method comprises:
determining a distortion value of a current video block of the video based on a set of distortion metrics, the set of distortion metrics comprising at least one of:
a first distortion metric determined according to a first machine learning model,
a second distortion metric determined according to a second machine learning model, or
a third distortion metric determined without using the first and second machine learning models; and
generating the bitstream based on the distortion value.
